(19) United States
(12) Patent Application Publication
(10) Pub. No.: US 2008/0060737 A1
(43) Pub. Date: Mar. 13, 2008

(54) TIRE FOR HEAVY LOADING VEHICLES

(75) Inventor: Naofumi EZAWA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 11/830,917

(22) Filed: Jul. 31, 2007

(30) Foreign Application Priority Data
Aug. 8, 2006 (JP) 215922/2006

(51) Int. Cl. B60C 9/14

(52) U.S. Cl. 152/549; 152/564

(57) ABSTRACT

Provided is a tire for heavy loading vehicles which is improved in an adhesion durability of a carcass ply layer to a large extent while maintaining a fracture resistance and a low heat generating property of a cushion rubber. The above tire is a tire for heavy loading vehicles which is provided with a carcass ply layer toroidally extending between a pair of bead cores, a belt layer reinforcing the carcass ply layer at an outside of the carcass ply layer in a tire radial direction and a cushion rubber provided between the carcass ply layer and the belt layer and extending to a shoulder part and the carcass ply layer comprising a carcass cord comprising a steel cord and a carcass rubber for covering the carcass cord, wherein the cushion rubber contains a rubber component comprising a diene base rubber, 1.5 to 4.0 parts by mass of the total sulfur content based on 100 parts by mass of the rubber component, zinc oxide so that a mass ratio (zinc oxide/total sulfur content) is 2.0 or more, and an organic acid.

### BACKGROUND OF THE INVENTION

1. Field of the Invention

The present invention relates to a tire for heavy loading vehicles which is improved in an adhesion durability in a shoulder part of the tire.

2. Description of the Related Art

In recent years, heavier loading, a higher speed and a longer life are requested to tires for heavy loading vehicles, particularly off-road tires in order to make transporting operations more efficient. If the use conditions of tires are shifted, as described above, to heavier loading and a higher speed, temperatures in a crown part and a shoulder part of the tires are elevated to accelerate a deterioration in an adhesive strength between a carcass rubber of a carcass ply layer in a shoulder part and a carcass cord comprising a steel cord, so that adhesion separation is caused during driving, and separation is brought about in a cushion rubber in a certain case because of higher deformation and more heat applied to the cushion rubber.

Methods such as an increase in a content of sulfur blended into the carcass rubber to a large extent and an increase in a thickness of the carcass rubber between the cushion rubber and the carcass cord to a large extent are available in order to enhance an adhesion durability of the carcass ply layer in the shoulder part.

Further, a method for improving a blend content of the cushion rubber is tried as well.

It is proposed in, for example, Patent Document 1 that a rubber composition containing 0.5 to 10 parts by weight of polymethoxymethylmelamine having 3 to 6 methoxymethyl groups and 0 to 3 methylol groups based on 100 parts by weight of a diene base rubber is used for a cushion rubber and the like.

Further, it is disclosed in a Patent Document 2 that a polysulfide compound is blended into a cushion rubber so that a content of a sulfur component in the polysulfide compound is within the range of 20 to 60% by mass based on the total amount of whole sulfur contained in the cushion rubber.

However, the vulcanization time is long in a large-sized tire having a thick shoulder part, and therefore the cushion rubber stays in an over-vulcanization condition even in an unused state. Further, a tire having a large cross-sectional dimension scarcely has penetration of oxygen and moisture, and a degradation in adhesion of carcass originates principally in degradation caused by heat and deformation. Under the above conditions, an increase in an amount of sulfur in the carcass rubber to a large extent makes it easy to cause separation in the back face part of the bead because of the inferior physical properties of the rubber after thermally degraded.

Further, an increase in a thickness of the carcass rubber between the cushion rubber and the carcass cord to a large extent elevates heat generation in the shoulder part to reduce the adhesion life over a rise in the performance.

Polymethoxymethylmelamine is blended into the cushion rubber for the purpose of inhibiting adhesion from being degraded by humidity and heat. In a tire for heavy loading vehicles which is a large-sized tire, however, oxygen and moisture do not penetrate into the cushion rubber, and therefore the above effect is small.

Further, an increase in an amount of sulfur contained in the cushion rubber to a large extent deteriorates a heat aging property of the cushion rubber, and if polysulfide is blended into the cushion rubber, breakage in an inside of the cushion rubber is liable to take place during running since the fracture characteristics of the rubber are low even in an unused state. Further, polysulfide such as Thiocol (brand name) is a liquid polymer, and therefore it is not easy to handle. Further, since vulcanization is notably expedited, scorch (rubber burning) is liable to take place, and adverse effects such as a rise in a viscosity of the unvulcanized rubber are exerted on a productivity of the tire.

On the other hand, use of carbon having a large particle diameter and a reduction in a carbon amount in order to reduce heat generation of the cushion rubber deteriorate a fracture resistance of the cushion rubber and make it easy to bring about breakage of the cushion rubber.
Patent Document 1: Japanese Patent Application Laid-Open No. 148986/2004
Patent Document 2: Japanese Patent Application Laid-Open No. 67358/2005

### SUMMARY OF THE INVENTION

In light of the situation described above, an object of the present invention is to provide a tire for heavy loading vehicles which is improved in an adhesion durability of a carcass ply layer to a large extent while maintaining a fracture resistance of a cushion rubber.

Intensive research repeated by the present inventor in order to achieve the object described above have resulted in finding that the above object can be achieved without changing the compounding recipe of a carcass rubber by optimizing the amounts of sulfur and zinc oxide each contained in a cushion rubber. The present invention has been completed based on the above knowledge.

That is, the present invention provides:
1. a tire for heavy loading vehicles which is provided with a carcass ply layer toroidally extending between a pair of bead cores, a belt layer for reinforcing the carcass ply layer at an outside of the carcass ply layer in a tire radial direction and a cushion rubber provided between the carcass ply layer and the belt layer and extending to a shoulder part and the carcass ply layer comprising a carcass cord comprising a steel cord and a carcass rubber for covering the carcass cord, wherein the cushion rubber contains a rubber component comprising a diene base rubber, 1.5 to 4.0 parts by mass of the total sulfur content based on 100 parts by mass of the rubber component, zinc oxide so that a mass ratio (zinc oxide/total sulfur content) is 2.0 or more, and an organic acid,
2. the tire for heavy loading vehicles as described in claim 1, wherein the cushion rubber contains 30 to 45 parts by mass of carbon black having an iodine absorption number within the range of 60 to 110 mg/g (measured according to JIS K 6217-1:2001) based on 100 parts by mass of the rubber component,
3. the tire for heavy loading vehicles as described in claim 1 or 2, wherein a maximum value H in a thickness of the shoulder part is 100 mm or more,
4. the tire for heavy loading vehicles as described in any of claims 1 to 3, wherein the carcass rubber between the cushion rubber and the carcass cord has a thickness satisfying the relation of the following equation (I):
   {thickness (mm) of carcass rubber}≦(parts by mass of organic acid blended into cushion rubber)×5 (I)
   and
5. the tire for heavy loading vehicles as described in any of claims 1 to 4, wherein the tire for heavy loading vehicles is an off-road tire.

According to the present invention, capable of being provided is a tire for heavy loading vehicles which is improved in an adhesion durability of a carcass ply layer to a large extent while maintaining a fracture resistance of a cushion rubber.

In the present invention, the invention can be carried out without using polysulfide, and therefore it is economical and does not reduce a productivity of the tire.

Further, the compounding recipe of the carcass rubber does not need to be changed, and therefore an adverse effect is not exerted on a separation performance on the back face of the bead part.

### BRIEF DESCRIPTIONS OF THE DRAWINGS

FIG. 1 is a semi-partial cross-sectional schematic drawing of the tire for heavy loading vehicles according to the present invention.

### EXPLANATIONS OF THE CODES

1: Tire for heavy loading vehicles
11: Bead core
12: carcass ply layer
13: Belt layer
14: Shoulder part
15: Cushion rubber
16: Side wall part

### BEST MODE FOR CARRYING OUT THE INVENTION

The preferred embodiment according to the present invention shall be explained below with reference to the drawing. The present invention shall not be restricted to the following embodiments and examples.

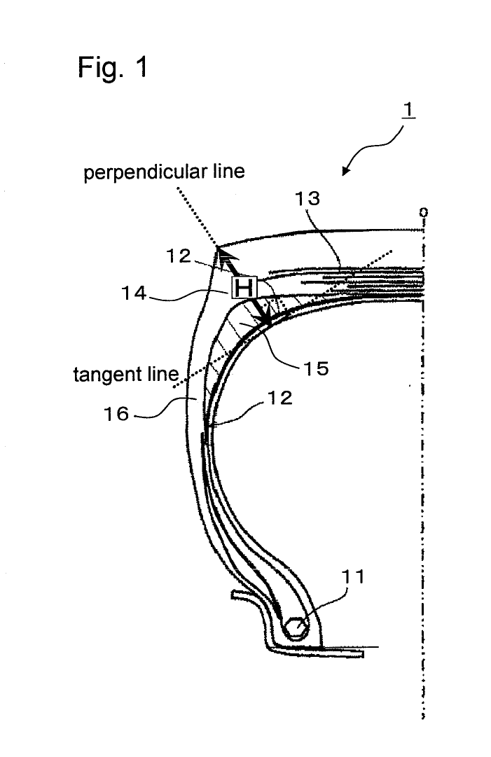

FIG. 1 is a semi-partial cross-sectional schematic drawing of the tire for heavy loading vehicles according to the present invention. As shown in FIG. 1, the tire 1 for heavy loading vehicles according to the present invention is provided with a carcass ply layer 12 extendedly present in a toroidal form between a pair of bead cores 11, a belt layer 13 for reinforcing the carcass ply layer 12 at an outside of the carcass ply layer 12 in a tire radial direction and a cushion rubber 15 provided between the carcass ply layer 12 and the belt layer 13 and extending to a shoulder part 14. The cushion rubber 15 preferably extends up to the shoulder part 14, and as shown in FIG. 1, a part of the cushion rubber 15 may extend, if necessary, up to a side wall part 16.

The carcass ply layer 12 comprises a carcass cord comprising a steel cord and a carcass rubber for covering the carcass cord.

The tire 1 for heavy loading vehicles according to the present invention includes off-road tires, tires for trucks and buses, large-sized tires for agriculture and the like. Among them, particularly the off-road tires which are large-sized tires can predominantly exhibit the effects of the present invention.

In this connection, an off-road tire is a tire used on off-roads other than ordinary roads and includes tires for mine haulage vehicles used in open-pit mines and rock quarries and tires for construction vehicles which work in construction sites of dams and the like.

In the tire 1 for heavy loading vehicles according to the present invention, the cushion rubber 15 contains a rubber component comprising a diene base rubber and 1.5 to 4.0 parts by mass of the total sulfur content based on 100 parts by mass of the rubber component and contains zinc oxide so that a mass ratio (zinc oxide/total sulfur content) is 2.0 or more, and it contains an organic acid.

If the total sulfur content is less than 1.5 parts by mass, the cushion rubber 15 is reduced in a tensile stress at break, and if it exceeds 4.0 parts by mass, the cushion rubber 15 deteriorates in a heat aging resistance.

Zinc oxide is added so that a mass ratio (zinc oxide/total sulfur content) is 2.0 or more in order to enhance an adhesion durability of the carcass ply layer as well as a heat aging resistance of the cushion rubber 15 itself and maintain a rupture resistance of the tire during running. The more the blend amount of zinc oxide, the better, and it is preferably 15 parts by mass or less, more preferably 12 parts by mass or less per 100 parts by mass of the rubber component. If a blend amount of zinc oxide exceeds 15 parts by mass, a rise in an adhesion durability of the carcass ply layer slows down, and the cost of zinc oxide is high. Accordingly, it is not advantageous in terms of economical efficiency.

In the present invention, adhesion means adhesion of the steel cord with rubber for covering it, that is, adhesion of the carcass cord with the carcass rubber.

The total sulfur content in the present invention means a total amount of sulfur which takes part in vulcanization. When the vulcanizing agent is only sulfur, it is equal to a blend amount of sulfur; when the vulcanizing agent is a sulfur donor other than sulfur, it is equal to a mass part of sulfur contained in the sulfur donor; and when the vulcanizing agent is sulfur and the sulfur donor described above, it is equal to the total mass part of the sulfur and sulfur contained in the sulfur donor described above.

Sulfur blended into the cushion rubber 15 according to the present invention is preferably powder sulfur for rubber prescribed in JIS K 6222-2:1998, and it may be precipitated sulfur, colloidal sulfur, insoluble sulfur and the like.

Zinc oxide blended into the cushion rubber 15 according to the present invention may be any ones as long as they are commercially available as zinc white for rubber. An American process, a French process, a wet process, a special process and the like are used as a production process therefor. Further, it may be activated zinc white having fine particles.

The organic acid blended into the cushion rubber 15 according to the present invention denotes linear or branched, saturated or unsaturated aliphatic, alicyclic or aromatic carboxylic acids having 3 to 30 carbon atoms.

To be specific, it includes stearic acid, palmitic acid, myristic acid, oleic acid, linoleic acid, linolenic acid, tall oil fatty acid, versatic acid, cyclopropanecarboxylic acid, benzoic acid, phthalic acid, isophthalic acid, terephthalic acid, phthalic monoesters, isophthalic monoesters, terephthalic monoesters and the like.

The cushion rubber 15 in the present invention contains preferably 30 to 45 parts by mass of carbon black having an iodine absorption number within the range of 60 to 110 mg/g (measured according to JIS K 6217-1:2001) based on 100 parts by mass of the rubber component.

If the iodine absorption number is 60 mg/g or more, the rupture resistance is improved. If it is 110 mg/g or less, the kneading workability is enhanced, and a dispersibility of carbon black is improved.

The specific examples of carbon black having an iodine absorption number within the range of 60 to 110 mg/g include HAF-LS (N326), HAF (N330), HAF-HS (N347), N339, N351, IISAF (N285), IISAF-HS (N229), ISAF-LS (N219) and the like.

Silica may be blended, if necessary, in addition to the carbon black described above into the cushion rubber 15. Silica is preferably wet silica. When silica is blended, a silane coupling agent is preferably blended in a proportion of 1 to 30% by mass, particularly 5 to 20% by mass based on silica.

The diene base rubber used for the cushion rubber 15 in the present invention includes, for example, natural rubber (NR), polyisoprene synthetic rubber (IR), cis-1,4-polybutadiene rubber (BR), styrene-butadiene rubber (SBR), acrylonitrile-butadiene rubber (NBR), chloroprene rubber (CR), butyl rubber (IIR), halogenated butyl rubber, ethylene-propylene-diene ternary copolymers (EPDM) and the like. The rubbers may be used alone or in combination of two or more kinds thereof. Among the rubber components described above, the natural rubber is preferred from the viewpoint of securing the low heat generating property and the adhesive property.

A maximum value H in a thickness of the shoulder part in the tire 1 for heavy loading vehicles according to the present invention is preferably 100 mm or more. If it is 100 mm or more, the effects of the present invention can more predominantly be exhibited. The maximum value H includes as well a maximum value in a thickness of a shoulder part in a tire which is the biggest in the world at present, but since the size of tires are considered to be enlarged furthermore in the future, an upper limit of a maximum value H in a thickness of a shoulder part should not be restricted. In this respect, a maximum value H in a thickness of a shoulder part means, as shown by H and both arrows in FIG. 1, a maximum value in a distance from an inner surface of a tire to an end part of a tire ground part in a perpendicular line which stands from a tangent line on an inner surface of the tire and which starts from the contact point of the tangent line on the inner surface of the tire through the end part of the tire ground part.

In the tire 1 for heavy loading vehicles according to the present invention, the carcass rubber between the cushion rubber 15 and the carcass cord has preferably a thickness satisfying the following equation:
{thickness (mm) of carcass rubber}≦(parts by mass of organic acid blended into cushion rubber)×5 (I)

If the carcass rubber has a thickness within the above range, the adhesion durability is improved furthermore, and therefore it is preferred. Further, a lower limit of 0.2 mm or more is preferred since the adhesion durability is secured, and a lower limit of 0.5 mm or more is more preferred because of the same reason.

In the present invention, various blending agents, which are usually used in the rubber industry, such as vulcanization accelerators, vulcanization accelerator auxiliaries, antioxidants, softening agents, scorch inhibitors and the like can suitably be blended in addition to the respective components described above into the cushion rubber 15.

The cushion rubber 15 can be produced by kneading by means of a conventional Banbury mixer, an international mixer or a roll. The tire 1 for heavy loading vehicles according to the present invention can be produced by means of a conventional molding machine and a vulcanizing equipment.

### EXAMPLES

Next, the present invention shall be explained in further details with reference to examples, but the present invention shall by no means be restricted by these examples.

The rubber covering rate and the tensile stress at break were measured according to the following methods.

(1) Rubber Covering Rate

A test tire having a tire size of 18. 00R25 ran on a step road (load: TRA standard 100%·10 ton, internal pressure: 800 kPa, load is raised by 20% every 72 hours) at a speed of 20 km/h for 320 hours and then stopped to determine visually a rubber covering rate (%) of a carcass cord in a region within 100 mm in a carcass cord direction centering around a maximum value in a thickness of the cushion rubber of the test tire.

(2) Tensile Stress at Break (TS_{b})

A cushion rubber was cut out from a new test tire in the form of a sheet having a thickness of 2 mm and aged under nitrogen atmosphere of 100° C. for 30 days, and then the tensile stress at break was measured at room temperature (25° C.) according to JIS K 6251-1:2004. The result obtained was shown by an index according to the following equation (II), wherein a value obtained in Comparative Example 1 was set to 100. The larger the index, the better the tensile stress.
TS_{b} index=(TS_{b} value of test tire/TS_{b} value of Comparative Example 1)×100 (II)

### Examples 1 to 9 and Comparative Examples 1 to 3

Produced were twelve kinds of test tires having a tire size of 18. 00R25 in which cushion rubbers having compounding recipes shown in Table 1 were provided as shown in FIG. 1. Twelve kinds of these test tires were used for measuring a rubber covering rate and a tensile stress at break. The results thereof are shown in Table 1.

TABLE 1

| | | | | | | | | | | Comparative | | |
|---|---|---|---|---|---|---|---|---|---|---|---|---|
| | Example | | | | | | | | | Example | | |
| | 1 | 2 | 3 | 4 | 5 | 6 | 7 | 8 | 9 | 1 | 2 | 3 |
| compounding recipes | | | | | | | | | | | | |
| Natural rubber¹⁾ | 100 | 100 | 100 | 100 | 100 | 100 | 100 | 100 | 100 | 100 | 100 | 100 |
| Carbon black²⁾ | 40 | 40 | 40 | 40 | 40 | 40 | 40 | 30 | 45 | 40 | 40 | 40 |
| Antioxidant³⁾ | 1 | 1 | 1 | 1 | 1 | 1 | 1 | 1 | 1 | 1 | 1 | 1 |
| Stearic acid | 2 | 2 | 2 | 2 | 2 | 2 | 2 | 2 | 2 | 2 | 2 | 2 |
| Zinc oxide | 5 | 7 | 9 | 9 | 3 | 7 | 8 | 5 | 5 | 5 | 4 | 7 |
| Vulcanization accelerator⁴⁾ | 1 | 1 | 1 | 1 | 1 | 1 | 4 | 1 | 1 | 1 | 1 | 1 |
| Sulfur | 2 | 3 | 2 | 3 | 1.5 | 1.5 | 4 | 2 | 2 | 4 | 3 | 1 |
| (Zinc oxide/total sulfur | 2.5 | 2.3 | 4.5 | 3.0 | 2.0 | 4.7 | 2.0 | 2.5 | 2.5 | 1.3 | 1.3 | 7.0 |
| content) mass ratio | | | | | | | | | | | | |
| Evaluation results of tires | | | | | | | | | | | | |
| Rubber covering rate (%) | 100 | 100 | 100 | 100 | 96 | 96 | 98 | 100 | 100 | 80 | 60 | 75 |
| Tensile stress at break (index) | 131 | 114 | 125 | 121 | 119 | 133 | 106 | 122 | 125 | 100 | 107 | 133 |

Remarks:
¹⁾RSS #3
²⁾N330, “(brand name) Seast 3” manufactured by Tokai Carbon Co., Ltd., iodine absorption number (measured according to JIS K 6217-1: 2001): 80 mg/g
³⁾N-(1,3-dimethylbutyl)-N′-phenyl-p-phenylenediamine, “(brand name) Nocrac 6C” manufactured by Ouchi Shinko Chemical Industrial Co., Ltd.
⁴⁾N,N-dicyclohexyl-2-benzothiazylsulfenamide, “(brand name) Nocceler DZ” manufactured by Ouchi Shinko Chemical Industrial Co., Ltd.

As can be found from the results shown in Table 1, both of the rubber covering rates after running on the drum and the tensile stresses at break after thermally aged under nitrogen atmosphere of the tires for heavy loading vehicles produced in Examples 1 to 9 were much better than those of the tires for heavy loading vehicles produced in Comparative Examples 1 to 3, and the adhesion durability of the carcass ply layers in the tires of Examples 1 to 9 were improved to a large extent while maintaining a rupture resistance of the cushion rubbers.

### INDUSTRIAL APPLICABILITY

The tires for heavy loading vehicles according to the present invention are suitably used for various vehicles for off-roads, trucks, buses, large-sized vehicles for agriculture, particularly various vehicles for off-roads.

1. A tire for heavy loading vehicles which is provided with a carcass ply layer toroidally extending between a pair of bead cores, a belt layer for reinforcing the carcass ply layer at an outside of the carcass ply layer in a tire radial direction and a cushion rubber provided between the carcass ply layer and the belt layer and extending to a shoulder part and the carcass ply layer comprising a carcass cord comprising a steel cord and a carcass rubber for covering the carcass cord, wherein the cushion rubber contains a rubber component comprising a diene base rubber, 1.5 to 4.0 parts by mass of the total sulfur content based on 100 parts by mass of the rubber component, zinc oxide so that a mass ratio (zinc oxide/total sulfur content) is 2.0 or more, and an organic acid.

2. The tire for heavy loading vehicles as described in claim 1, wherein the cushion rubber contains 30 to 45 parts by mass of carbon black having an iodine absorption number within the range of 60 to 110 mg/g (measured according to JIS K 6217-1:2001) based on 100 parts by mass of the rubber component.

3. The tire for heavy loading vehicles as described in claim 1, wherein a maximum value H in a thickness of the shoulder part is 100 mm or more.

4. The tire for heavy loading vehicles as described in claim 1, wherein the carcass rubber between the cushion rubber and the carcass cord has a thickness satisfying the relation of the following equation (I):
{thickness (mm) of carcass rubber}≦(parts by mass of organic acid blended into cushion rubber)×5 (I).

5. The tire for heavy loading vehicles as described in claim 1, wherein the tire for heavy loading vehicles is an off-road tire.
